(19) United States
(12) Patent Application Publication
(10) Pub. No.: US 2023/0179019 A1
(43) Pub. Date: Jun. 8, 2023

(54) Wireless Charging Apparatus and Electronic Device

(71) Applicant: Honor Device Co., Ltd., Shenzhen (CN)

(72) Inventors: Yuan Wu, Shenzhen (CN); Wei Zhang, Shenzhen (CN); Feng Wang, Shenzhen (CN); Chao Wang, Shenzhen (CN); Lilie Zhao, Shenzhen (CN); Hua Huang, Shenzhen (CN)

(21) Appl. No.: 17/995,871

(22) PCT Filed: Jan. 5, 2022
(86) PCT No.: PCT/CN2022/070387

§ 371 Date: Oct. 10, 2022

(30) Foreign Application Priority Data
Mar. 26, 2021 (CN) 202110326601.1

(51) Int. Cl. H02J 50/00; H02J 50/10; H02J 50/50; G06F 3/023

(52) U.S. Cl. CPC H02J 50/005; G06F 3/0231; H02J 50/10; H02J 50/502; G06F 3/0213

(57) ABSTRACT

A wireless charging apparatus which includes: an accommodation structure and a first charging control circuit. The accommodation structure includes an accommodation cavity and a first wireless charging coil, where the first wireless charging coil can be arranged around the accommodation cavity. In addition, the first wireless charging coil generate an alternating current magnetic field. The accommodation cavity is configured to accommodate a stylus, and a second wireless charging coil is arranged in the stylus. When the stylus is accommodated in the accommodation cavity, the second wireless charging coil is also accommodated in the first wireless charging coil. In this case, the second wireless charging coil can induce an alternating current magnetic field generated by the first wireless charging coil in a plurality of directions, to be coupled to the first wireless charging coil.

### CROSS-REFERENCE TO RELATED APPLICATIONS

This application is a National Stage of International Application No. PCT/CN2022/070387, filed on Jan. 5, 2022, which claims priority to Chinese Patent Application No. 202110326601.1, filed on Mar. 26, 2021, both of which are hereby incorporated by reference in their entireties.

### TECHNICAL FIELD

Embodiments of this application relate to the field of wireless charging technologies, and in particular, to a wireless charging apparatus and an electronic device.

### BACKGROUND

Currently, electronic devices, such as mobile phones and tablet computers, may all be equipped with a stylus. A user may use the stylus to enter information, such as texts and images, to the electronic device. Generally, the stylus may be charged in two modes, that is, a wired charging mode and a wireless charging mode.

Using the wireless charging mode as an example, as shown in FIG. 1, a charging coil (not shown in FIG. 1) is arranged at a top portion 103 of an electronic device 102, and a user can attach a stylus 101 to the top portion 103 of the electronic device 102. Further, the charging coil of the electronic device 102 may exchange energy with a charging coil of the stylus 101, to transmit electrical energy of the electronic device 102 to the stylus 101, that is, charge the stylus 101.

In this charging mode, when the charging coil of the electronic device 102 exchanges energy with the charging coil of the stylus 101, energy loss may occur, resulting in lower charging efficiency, a longer charging time, and higher power consumption of the electronic device 102.

### SUMMARY

Embodiments of this application provide a wireless charging apparatus and an electronic device, to improve the charging efficiency during wireless charging and reduce power consumption overheads caused by wireless charging.

According to a first aspect, this application provides a wireless charging apparatus, including: an accommodation structure and a first charging control circuit. The accommodation structure specifically includes an accommodation cavity and a first wireless charging coil (that is, a TX coil), where the first wireless charging coil can be arranged around the accommodation cavity. In addition, the first wireless charging coil may be connected to the first charging control circuit. The first charging control circuit is configured to output an alternating current signal to the first wireless charging coil, causing the first wireless charging coil to generate an alternating current magnetic field.

The accommodation cavity is configured to accommodate a stylus, and a second wireless charging coil (that is, an RX coil) is arranged in the stylus. When the stylus is accommodated in the accommodation cavity, the second wireless charging coil is also accommodated in the first wireless charging coil. In this case, the second wireless charging coil can induce an alternating current magnetic field generated by the first wireless charging coil in a plurality of directions, to be coupled to the first wireless charging coil.

Compared with the prior art, in which during wireless charging, an RX coil is arranged side by with and symmetrically with a TX coil, to induce an alternating current magnetic field on a side of the TX coil, when the wireless charging apparatus provided in this application charges the stylus, the second wireless charging coil (that is, the RX coil) in the stylus can be accommodated in the first wireless charging coil (that is, the TX coil), so as to induce an alternating current magnetic field generated by the TX coil in all directions, and improve a coupling coefficient between the RX coil and the TX coil, thereby improving a charging speed and the charging efficiency during wireless charging while reducing power consumption overheads caused by wireless charging.

In a possible implementation, a size of the accommodation cavity may correspond to a size of the stylus, and/or a shape of the accommodation cavity may correspond to a shape of the stylus, so that the stylus can be easily accommodated in the accommodation cavity. Certainly, the shape of the accommodation cavity may alternatively be different from the shape of the stylus. For example, a cross-section of the stylus may be polygonal, and a cross-section of the accommodation cavity may be circular.

In a possible implementation, the wireless charging apparatus further includes a battery, where the battery is connected to the first charging control circuit. The battery is configured to output a direct current signal to the first charging control circuit. Further, the first charging control circuit can convert the received direct current signal into an alternating current signal.

In a possible implementation, the wireless charging apparatus further includes a charging interface, where the charging interface is connected to the first charging control circuit. The charging interface is configured to obtain a direct current signal from a power adapter, a mobile power supply, or a first electronic device, and output the direct current signal to the first charging control circuit. Further, the first charging control circuit can convert the received direct current signal into an alternating current signal.

That is, the first charging control circuit may obtain a corresponding electrical signal from the battery to wirelessly charge the stylus, or the first charging control circuit may obtain a corresponding electrical signal from the charging interface to wirelessly charge the stylus.

In a possible implementation, the wireless charging apparatus further includes a third wireless charging coil, where the third wireless charging coil is connected to a second charging control circuit. The third wireless charging coil is configured to receive an alternating current magnetic field generated by a second electronic device, to generate an alternating current signal, and output the generated alternating current signal to the second charging control circuit. That is, the wireless charging apparatus may serve as an RX device, to be wirelessly charged by another device through the third wireless charging coil.

Further, the second charging control circuit may be connected to a battery. The second charging control circuit can rectify the received alternating current signal into a direct current signal, and output the direct current signal to the battery.

In a possible implementation, the accommodation structure may further include a casing, where the first wireless charging coil is arranged between the casing and the accommodation cavity.

In a possible implementation, the wireless charging apparatus may be specifically a Bluetooth keyboard, where the Bluetooth keyboard includes a keyboard body and a cover plate, and the keyboard body and the cover plate are hingedly connected to each other by a rotary shaft. A part or all of the rotary shaft may be the accommodation structure. For example, a casing of the rotary shaft may be the same as a casing of the accommodation structure. In this way, the accommodation structure can be arranged by using an original rotary shaft in the Bluetooth keyboard, so that the stylus can be accommodated without adding a mechanical structure, and the charging efficiency of the stylus can also be increased.

According to a second aspect, an embodiment of this application provides an electronic device, including a memory, one or more processors, and the wireless charging apparatus. The first wireless charging coil (that is, the TX coil) arranged in the wireless charging apparatus is configured to wirelessly charge another device (for example, a stylus). The memory is configured to store computer program code. The computer program code includes computer instructions. When executing the computer instructions, the processor can control the wireless charging apparatus to wirelessly charge the another device.

It can be understood that, for beneficial effects that can be achieved by the electronic device described in the second aspect provided above, reference may be made to beneficial effects in the first aspect and any possible design manner thereof, and details are not described herein again.

### BRIEF DESCRIPTION OF THE DRAWINGS

FIG. 1 is a schematic diagram of a scenario in which a tablet computer wirelessly charges a stylus in the prior art;

FIG. 2 is a schematic diagram 1 of a principle of wireless charging according to an embodiment of this application;

FIG. 3 is a schematic diagram 2 of a principle of wireless charging according to an embodiment of this application;

FIG. 4 is a schematic structural diagram 1 of an accommodation structure according to an embodiment of this application;

FIG. 5 is a schematic structural diagram 2 of an accommodation structure according to an embodiment of this application;

FIG. 6 is a schematic structural diagram 3 of an accommodation structure according to an embodiment of this application;

FIG. 7 is a schematic structural diagram 4 of an accommodation structure according to an embodiment of this application;

FIG. 8 is a schematic structural diagram 1 of a Bluetooth keyboard according to an embodiment of this application;

FIG. 9 is a schematic structural diagram 2 of a Bluetooth keyboard according to an embodiment of this application;

FIG. 10 is a schematic structural diagram 3 of a Bluetooth keyboard according to an embodiment of this application;

FIG. 11 is a schematic structural diagram 4 of a Bluetooth keyboard according to an embodiment of this application;

FIG. 12 is a schematic structural diagram 5 of a Bluetooth keyboard according to an embodiment of this application; and

FIG. 13 is a schematic structural diagram of an electronic device according to an embodiment of this application.

### DETAILED DESCRIPTION OF ILLUSTRATIVE EMBODIMENTS

An embodiment of this application provides a wireless charging apparatus, applicable to a process in which an electronic device wirelessly charges another electronic device. An electronic device that provides electrical energy can be referred to as a transmitter device (that is, a TX device), and an electronic device that receives electrical energy can be referred to as a receiver device (that is, an RX device).

First, the principle according to which the TX device wirelessly charges the RX device is described.

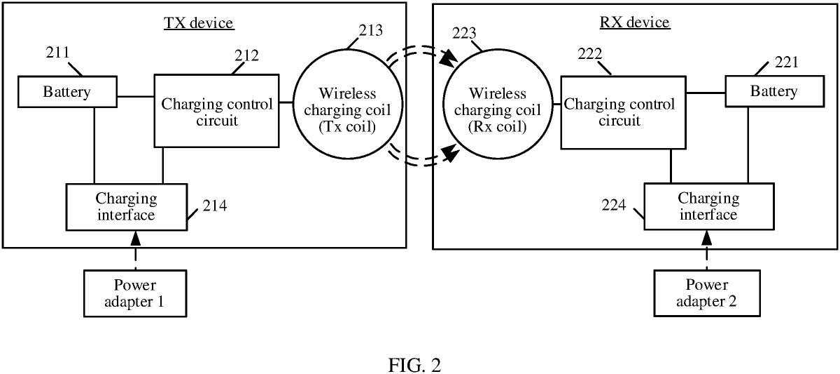

Exemplarily, as shown in FIG. 2, the TX device may include: a battery 211, a charging control circuit 212, a wireless charging coil 213, and a charging interface 214. The RX device may include: a battery 221, a charging control circuit 222, a wireless charging coil 223, and a charging interface 224.

The wireless charging coil 213 of the TX device may be referred to as a transmit (Tx) coil, and the wireless charging coil 223 of the RX device may be referred to as a receive (Rx) coil. The wireless charging coil (that is, the Tx coil) 213 is coupled to the wireless charging coil (that is, the Rx coil) 223.

When the TX device wirelessly charges the RX device, the charging control circuit 212 of the TX device can obtain a corresponding direct current signal from the battery 211. In addition, the charging control circuit 212 can convert the direct current signal into an alternating current signal, and then input the alternating current signal to the wireless charging coil 213. The wireless charging coil 213 can generate an alternating current magnetic field in response to the alternating current signal.

Alternatively, the charging control circuit 212 of the TX device may obtain an electrical signal inputted from an external power supply through the charging interface 214. For example, after the TX device is connected to a power adapter (that is, a wired charger) by the charging interface 214, the power adapter can convert the alternating current signal into a direct current signal and then input the direct current signal to the charging control circuit 212. Further, the charging control circuit 212 may convert the direct current signal into an alternating current signal, and then input the alternating current signal to the wireless charging coil 213, causing the wireless charging coil 213 to generate an alternating current magnetic field.

Correspondingly, when the TX device wirelessly charges the RX device, the RX device can induce the alternating current magnetic field emitted by the wireless charging coil (that is, the Tx coil) 213 by using the wireless charging coil (that is, the Rx coil) 223, to generate an alternating current signal, and input the alternating current signal to the charging control circuit 222. The charging control circuit 222 can rectify the alternating current signal into a direct current signal, and input the direct current signal to the battery 221, to charge the battery 221, thereby implementing wireless charging.

During wireless charging, the charging efficiency is related to a coupling coefficient K between the wireless charging coil 223 and the wireless charging coil 213. The coupling coefficient K refers to a ratio of actual mutual inductance (absolute value) between the wireless charging coil 223 and the wireless charging coil 213 to a maximum limit value thereof. A larger coupling coefficient K means more magnetic flux received by the wireless charging coil 223, and higher charging efficiency.

A value range of the coupling coefficient K can be 0 to 1. When the coupling coefficient K approaches 1, almost all magnetic flux generated by the wireless charging coil 213 is received by the wireless charging coil 223. When the coupling coefficient K approaches 0, the wireless charging coil 213 and the wireless charging coil 223 are independent of each other, and the wireless charging coil 223 hardly receives the magnetic flux generated by the wireless charging coil 213.

Generally, a magnitude of the coupling coefficient K is related to factors such as a distance, a size ratio, and an angle between the wireless charging coil 213 and the wireless charging coil 223, as well as coil shapes, coil materials, and magnetic core materials of the wireless charging coil 213 and the wireless charging coil 223.

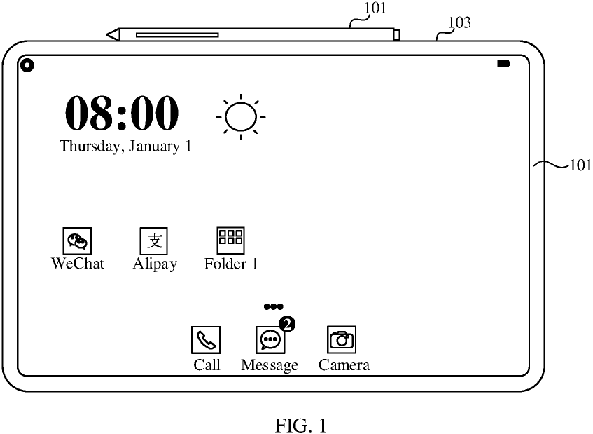

As shown in FIG. 1, in the prior art, the RX device (that is, a stylus 101) can be attached to a top portion of the TX device (that is, a tablet computer 101) for wireless charging. During wireless charging, an RX coil in the stylus 101 and a TX coil in the tablet computer 101 are symmetrically arranged side by side. In this case, the RX coil can induce an alternating current magnetic field generated on a side close to the TX coil. That is, the RX coil can receive only magnetic flux generated on an outer side of the TX coil. As a result, the TX coil and the RX coil are unilaterally coupled.

In the embodiments of this application, the wireless charging coil 223 can be accommodated in the wireless charging coil 213 by changing a positional relationship between the wireless charging coil 213 in the TX device and the wireless charging coil 223 in the RX device. In this case, the wireless charging coil 223 can induce an alternating current magnetic field generated by the wireless charging coil 213 in all directions, to increase magnetic flux received by the wireless charging coil 223, that is, increase the coupling coefficient K between the wireless charging coil 213 and the wireless charging coil 223, thereby improving the charging efficiency during wireless charging. This will be described in detail in the following embodiments, and therefore, is not described herein in detail.

It should be noted that, the TX device can also support wired charging. Still as shown in FIG. 2, when a power adapter 1 (that is, a wired charger) connected to a power supply is connected to the charging interface 214, the charging control circuit 212 can input power obtained from the charging interface 214 into the battery 211, to charge the battery 211. For example, the charging interface 214 may be a universal serial bus (universal serial bus, USB) interface.

Similarly, the RX device may also support wired charging. Still as shown in FIG. 2, a charging interface 224 of the RX device is configured to connect to a power adapter 2 for charging the RX device in a wired manner. When the power adapter 2 connected to the power supply is connected to the charging interface 224, for the principle according to which devices in the RX device interact with each other to charge the battery 221, reference may be made to the principle of wired charging of the TX device, and details are not described herein again.

Certainly, the RX device or the TX device may further include one or more components such as a processor, a memory, or a display screen, which is not limited in this embodiment of this application.

Based on the foregoing principle of wireless charging, FIG. 3 is a schematic architectural diagram of a wireless charging system according to an embodiment of this application. As shown in FIG. 3, the wireless charging system 300 may include a TX device 310 and an RX device 320. An accommodation structure 301 is arranged on the TX device 310. The accommodation structure 301 can be configured to accommodate the RX device 320.

When the RX device 320 is accommodated in the accommodation structure 301, the TX device 310 can transmit a wireless charging signal to the RX device 320 by using the accommodation structure 301, to wirelessly charge the RX device 320.

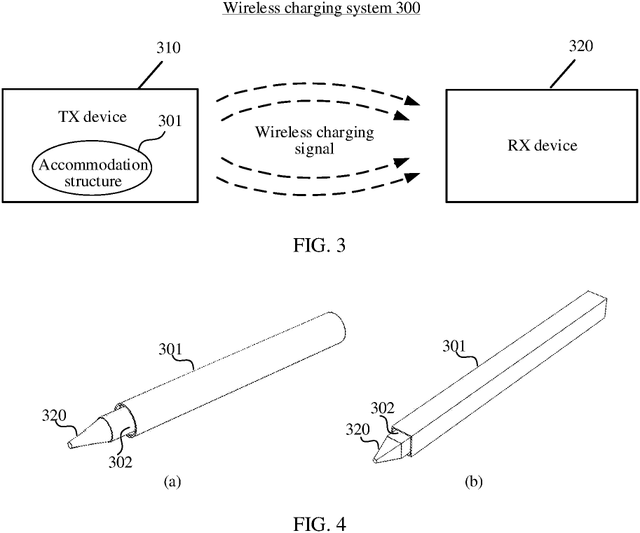

A device shape of the RX device 320 may match a shape of an accommodation cavity in the accommodation structure 301. For example, as shown in (a) of FIG. 4, when the RX device 320 is a cylindrical stylus, a shape of an accommodation cavity 302 in the accommodation structure 301 may also correspondingly be cylindrical. In another example, as shown in (b) of FIG. 4, when the RX device 320 is a cuboid stylus, the shape of the accommodation cavity 302 in the accommodation structure 301 may also correspondingly be a cuboid. Alternatively, the shape of the accommodation cavity 302 in the accommodation structure 301 may be different from the shape of the RX device 320 such as a stylus. For example, the accommodation cavity 302 in the accommodation structure 301 may be cylindrical, while a cross section of the stylus may be hexagonal, which is not limited in this embodiment of this application.

Exemplarily, the TX device 110 may be an electronic device that can wirelessly charge another device, for example, a Bluetooth keyboard, a mobile phone, a tablet computer, a desktop computer, a laptop computer, a handheld computer, a notebook computer, an ultra-mobile personal computer (ultra-mobile personal computer, UMPC), a netbook, a cellular phone, a personal digital assistant (personal digital assistant, PDA), an augmented reality (augmented reality, AR)\virtual reality (virtual reality, VR) device, or an in-vehicle device.

Exemplarily, the RX device 120 may be an electronic device that can receive wireless charging input from another device, for example, such as a stylus, a wearable device (such as a smart watch), or a true wireless stereo (true wireless stereo, TWS) headset.

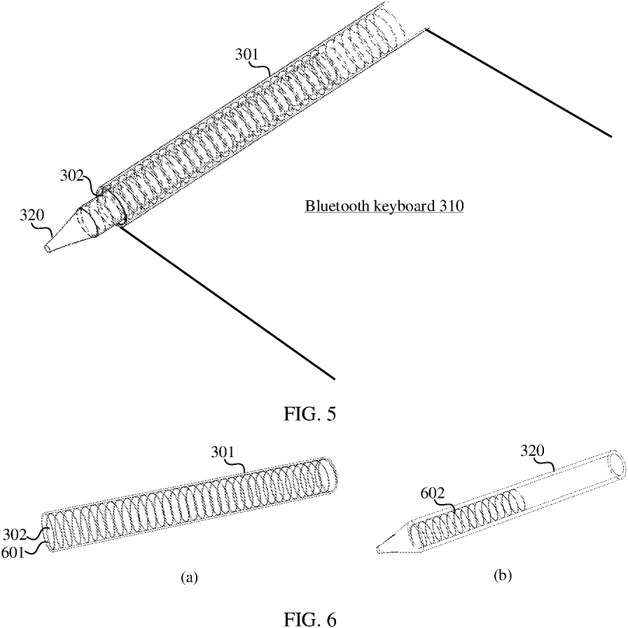

For example, the RX device 320 is a stylus, and the TX device 310 is a Bluetooth keyboard. As shown in FIG. 5, the accommodation structure 301 is arranged on the Bluetooth keyboard 310. The accommodation structure 301 can be configured to accommodate the stylus 320. For example, a size of the accommodation cavity 302 in the accommodation structure 301 corresponds to a size of the stylus 320, and a shape of the accommodation cavity 302 in the accommodation structure 301 corresponds to a shape of the stylus 320.

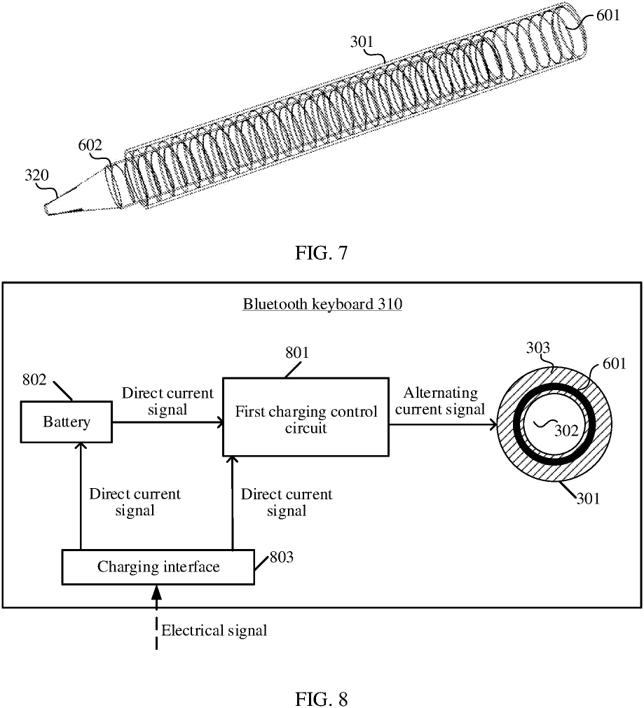

In an embodiment of this application, as shown in (a) of FIG. 6, a TX coil (also referred to as a first wireless charging coil) 601 may be arranged around the accommodation cavity 302 of the accommodation structure 301. For example, the TX coil 601 may be wound around a hollow frame made of a non-magnetic conductive material, to form the foregoing accommodation structure 301. In this case, an interior of the hollow frame is the foregoing accommodation cavity 302. Correspondingly, as shown in (b) of FIG. 6, an RX coil (also referred to as a second wireless charging coil) 602 is arranged along a stylus body or a part of the stylus body in the stylus 320. After the stylus 320 is accommodated in the accommodation structure 301, as shown in FIG. 7, the RX coil 602 is also accommodated in the TX coil 601. Exemplarily, after the RX coil 602 is accommodated in the TX coil 601, an axis of the RX coil 602 is parallel to or tends to be parallel to an axis of the TX coil 601.

Exemplarily, when the TX coil 601 and the RX coil 602 are symmetrically arranged side by side, the RX coil 602 can induce an alternating current magnetic field generated near a side of the TX coil 601. In this case, a coupling coefficient K1 between the TX coil 601 and the RX coil 602 is about 0.25. It can be known from the principle of electromagnetic induction that, when the RX coil 602 is accommodated inside the TX coil 601, more magnetic lines of induction generated by the TX coil 601 can pass through the RX coil 602, and the RX coil 602 can induce an alternating current magnetic field generated by the TX coil 601 in all directions. In this case, a coupling coefficient K₂ between the TX coil 601 and the RX coil 602 may be increased to 0.7. In this way, in a case that a transmit power of the Bluetooth keyboard 310 (that is, the TX device) is constant during wireless charging, because the coupling coefficient can be increased from 0.25 to 0.7, the receiving efficiency of the stylus 320 (that is, the RX device) for receiving electrical energy is significantly increased. Therefore, the entire charging process is faster, the charging efficiency is higher, and the power consumed by the TX device for wireless charging is also reduced.

In some embodiments, a magnetic core, such as a ferrite core, may further be arranged in the RX coil 602 of the stylus 320. When the RX coil 602 is accommodated inside the TX coil 601, the RX coil 602 can share the magnetic core in the RX coil 602 with the TX coil 601, thereby improving a coupling coefficient K between the TX coil 601 and the RX coil 602, so that the entire charging process is faster, and the charging efficiency is higher.

In addition, the stylus 320 is unlikely to be dropped after being accommodated in the accommodation structure 301 of the Bluetooth keyboard 310, which can reduce the probability of losing the stylus 320.

In some embodiments, for example, the TX device is still the Bluetooth keyboard 310. As shown in FIG. 8 (the accommodation structure 301 shown in FIG. 8 is a cross-sectional view of the accommodation structure 301), the foregoing accommodation structure 301 may specifically include a casing 303, an accommodation cavity 302, and a TX coil 601. The TX coil 601 can be arranged around the accommodation cavity 302, and the accommodation cavity 302 is configured to accommodate the stylus 320, so that the RX coil 602 in the stylus 310 is accommodated in the TX coil 601. It should be noted that, a person skilled in the art can set a winding direction, a diameter, a quantity of winding layers, and a winding method of a wire in the TX coil 601 according to actual needs, which are not limited in this embodiment of this application.

Still as shown in FIG. 8, the TX coil 601 may be connected to a first charging control circuit 801 in the Bluetooth keyboard 310, and the first charging control circuit 801 may be connected to a battery 802 in the Bluetooth keyboard 310. When the Bluetooth keyboard 310 wirelessly charges the stylus 320, the first charging control circuit 801 can obtain a corresponding direct current signal from the battery 802. Further, the charging control circuit 802 may convert the direct current signal into an alternating current signal, and then input the alternating current signal to the TX coil 601, causing the TX coil 601 to generate an alternating current magnetic field.

Correspondingly, in addition to the RX coil 602, the stylus 320 may further include a charging control circuit and a battery. The RX coil 602 in the stylus 320 can induce the alternating current magnetic field emitted by the TX coil 601, to generate an alternating current signal, and output the alternating current signal to the charging control circuit of the stylus 320. Further, the charging control circuit of the stylus 320 can rectify the received alternating current signal into a direct current signal, and then input the direct current signal into the battery of the stylus 320, to implement wireless charging.

Alternatively, still as shown in FIG. 8, a charging interface 803, such as a USB interface, may further be arranged in the Bluetooth keyboard 310. The charging interface 803 may be connected to the first charging control circuit 801. When wirelessly charging the stylus 320, the Bluetooth keyboard 310 may further obtain a corresponding electrical signal from the charging interface 803, and then charge the stylus 320 based on the obtained electrical signal by using the TX coil 601.

For example, the charging interface 803 of the Bluetooth keyboard 310 may be connected to a power adapter (such as a wired charger). After the charging interface 803 is connected to the power adapter, the power adapter can convert an obtained alternating current signal into a direct current signal, and then transmit the direct current signal to the first charging control circuit 80₁ by using the charging interface 80₃. The first charging control circuit 80₁ can convert the direct current signal into an alternating current signal, and then input the alternating current signal to the TX coil 601, causing the TX coil 601 to generate an alternating current magnetic field.

For example, the charging interface 803 of the Bluetooth keyboard 310 may be connected to a mobile power supply (such as a power bank). After the charging interface 803 is connected to the mobile power supply, the mobile power supply can output a direct current signal to the charging interface 80₃, and then transmit the direct current signal to the first charging control circuit 801 by using the charging interface 80₃. The first charging control circuit 801 can convert the direct current signal into an alternating current signal, and then input the alternating current signal to the TX coil 601, causing the TX coil 601 to generate an alternating current magnetic field.

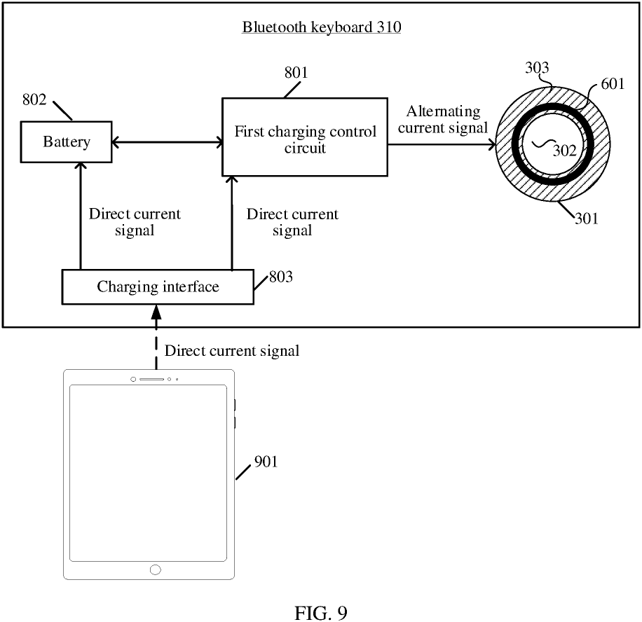

In another example, as shown in FIG. 9, the charging interface 803 of the Bluetooth keyboard 310 may be connected to an electronic device such as a mobile phone or a tablet computer. In this case, the electronic device provides electrical signals to the Bluetooth keyboard 310 as a mobile power supply. For example, after the charging interface 803 of the Bluetooth keyboard 310 is connected to a tablet computer 901, the tablet computer 901 can output a direct current signal to the charging interface 803, and then transmit the direct current signal to the first charging control circuit 801 by using the charging interface 80₃. The first charging control circuit 801 can convert the direct current signal into an alternating current signal, and then input the alternating current signal to the TX coil 601, causing the TX coil 601 to generate an alternating current magnetic field.

It should be noted that, regardless of whether the charging interface 803 of the Bluetooth keyboard 310 is connected to the power adapter, the mobile power supply, or the electronic device, the electrical signal obtained by the Bluetooth keyboard 310 from the charging interface 803 not only can charge the stylus 320 by using the TX coil 601, but also can charge the battery 802 of the Bluetooth keyboard 310, which is not limited in this embodiment of this application.

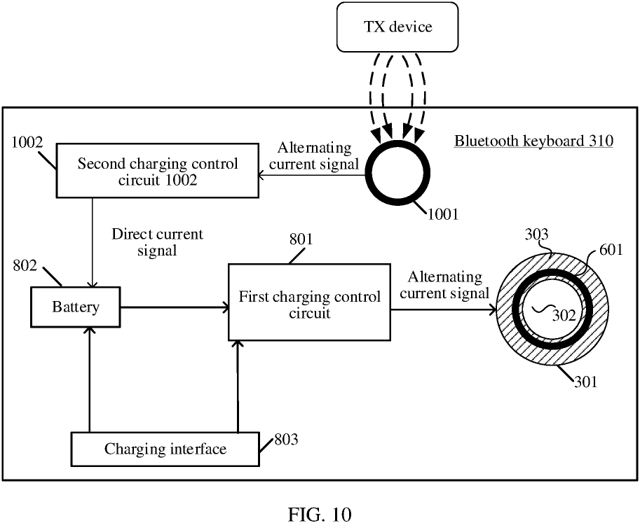

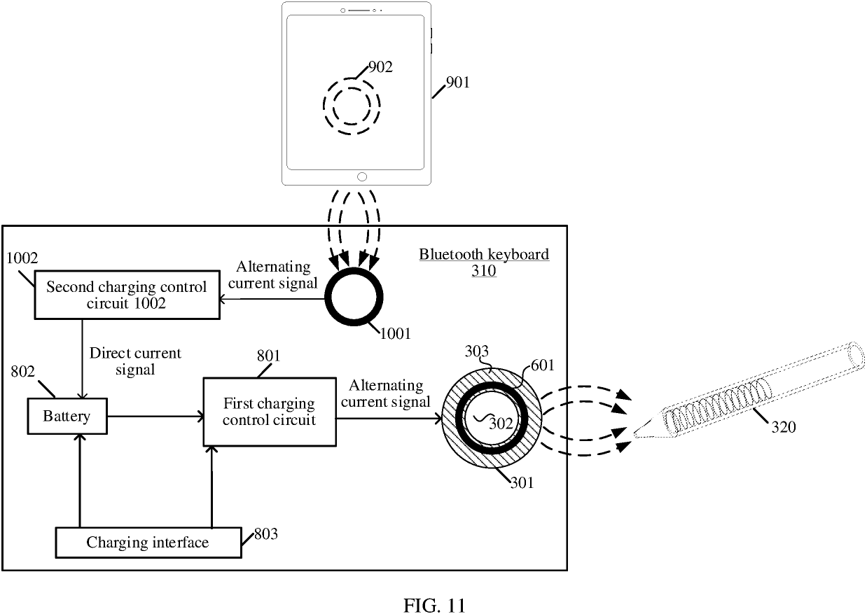

In other embodiments, the Bluetooth keyboard 310 may alternatively serve as an RX device to obtain electrical energy from another electronic device in a wireless charging mode. For example, as shown in FIG. 10, in addition to the TX coil 601, an RX coil (or referred to as a third wireless charging coil) 1001 can further be arranged in the Bluetooth keyboard 310, and the RX coil 1001 may be connected to a second charging control circuit 1002. The second charging control circuit 1002 is connected to the battery 802, and the second charging control circuit 1002 is configured to implement a wireless charging process when the Bluetooth keyboard 310 serves as the RX device. The RX coil 1001 can be configured to induce an alternating current magnetic field generated by another TX device (such as a tablet computer, a mobile phone, or a wireless charging base). Similar to the foregoing principle of wireless charging, the RX coil 1001 can generate an alternating current signal after inducing the alternating current magnetic field generated by the TX device, and output the alternating current signal to the second charging control circuit 1002. The second charging control circuit 1002 can rectify the received alternating current signal into a direct current signal, and output the direct current signal to the battery 802, to charge the battery 802 of the Bluetooth keyboard 310.

Exemplarily, for example, the Bluetooth keyboard 310 serves an RX device to be wirelessly charged by the tablet computer 901. As shown in FIG. 11, the RX coil 1001 is arranged on the Bluetooth keyboard 310, and a TX coil 902 is arranged on the tablet computer 901. When the tablet computer 901 wirelessly charges the Bluetooth keyboard 310, a user can make the RX coil 1001 on the Bluetooth keyboard 310 approach or come into contact with the TX coil 902 on the tablet computer 901. Further, similar to the foregoing principle of wireless charging, the tablet computer 901 can generate an alternating current magnetic field by using the TX coil 902, and the Bluetooth keyboard 310 can induce the alternating current magnetic field by using the RX coil 1001, to generate an alternating current signal. In addition, the RX coil 1001 of the Bluetooth keyboard 310 can output the generated alternating current signal to the second charging control circuit 1002. The second charging control circuit 1002 rectifies the received alternating current signal into a direct current signal, and then outputs the direct current signal to the battery 802. In addition, the first charging control circuit 801 can obtain the direct current signal from the battery 802, convert the direct current signal into an alternating current signal, and output the alternating current signal to the TX coil 601, causing the TX coil 601 to generate an alternating current magnetic field to charge the stylus.

The foregoing first charging control circuit 80₁ and the second charging control circuit 1002 may be arranged in one chip, or may be arranged in different chips, which is not limited in this embodiment of this application.

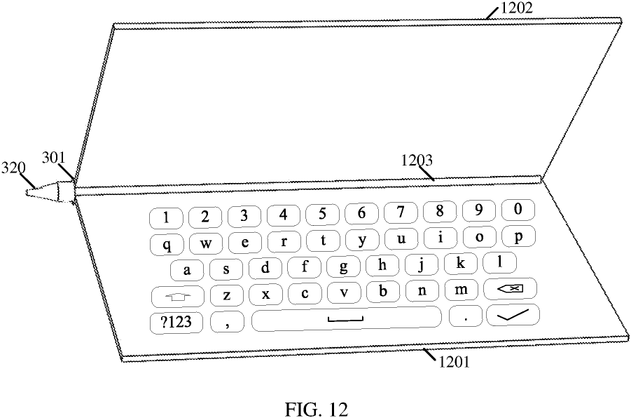

In other embodiments, for example, the TX device is still the Bluetooth keyboard 310. The foregoing accommodation structure 301 may be a part of a rotary shaft of the Bluetooth keyboard 310. As shown in FIG. 12, the Bluetooth keyboard 310 may include a keyboard body 1201 and a cover plate 1202, where the keyboard body 1201 and the cover plate 1202 are hingedly connected to each other by a rotary shaft 1203. A sleeve (or a part of the sleeve) of the rotary shaft 1203 may be the foregoing accommodation structure 301. In this way, the accommodation structure 301 can be arranged by using an original rotary shaft in the Bluetooth keyboard 310, the stylus 320 can be accommodated without adding a mechanical structure, and the charging efficiency of the stylus 320 can also be increased.

Certainly, in addition to the foregoing Bluetooth keyboard 310, the foregoing accommodation structure 301 may alternatively be arranged in another TX device to accommodate an RX device such as a stylus, so as to improve the charging efficiency during wireless charging. Using a mobile phone equipped with a foldable screen (or referred to as a foldable screen mobile phone) as an example, the foregoing accommodation structure 301 may be arranged on the rotary shaft of the foldable screen mobile phone, so that the stylus 320 can be accommodated in the foldable screen mobile phone, and the charging efficiency for the stylus 320 can also be improved. In another example, the foregoing accommodation structure 301 may be arranged on a side edge of a tablet computer, so that the stylus 320 can be accommodated, and the charging efficiency for the stylus 320 can be improved. For a specific method for wirelessly charging the RX device by the TX device, reference may be made to the method for wirelessly charging the stylus 310 by the Bluetooth keyboard 310 in the foregoing embodiment, and details are not described herein again.

Alternatively, the foregoing accommodation structure 301 may be independent of the TX device (for example, the foregoing Bluetooth keyboard 310). In this case, the accommodation structure 301 can be assembled with the TX device in the form of an independent device. After the accommodation structure 301 is assembled with the TX device, the RX device, such as the stylus 310, can still be accommodated, to improve the charging efficiency for the RX device, which is not limited in this embodiment of this application.

It should be noted that, when the foregoing Bluetooth keyboard 310 (that is, the TX device) wirelessly charges the stylus 310 (that is, the RX device), the wireless charging may be performed according to an existing wireless charging protocol. For example, the wireless charging protocol may be any protocol such as the Qi protocol, the Power Matters Alliance (Power Matters Alliance, PMA) protocol, or the Alliance for Wireless Power (Alliance for Wireless Power, A4WP) protocol, which is not described in detail in this embodiment of this application.

Other embodiments of this application provide an electronic device. The electronic device may include the foregoing accommodation structure 301. The TX coil in the foregoing accommodation structure 301 may be connected to a charging control circuit in the electronic device. The charging control circuit may be an IC chip or the like.

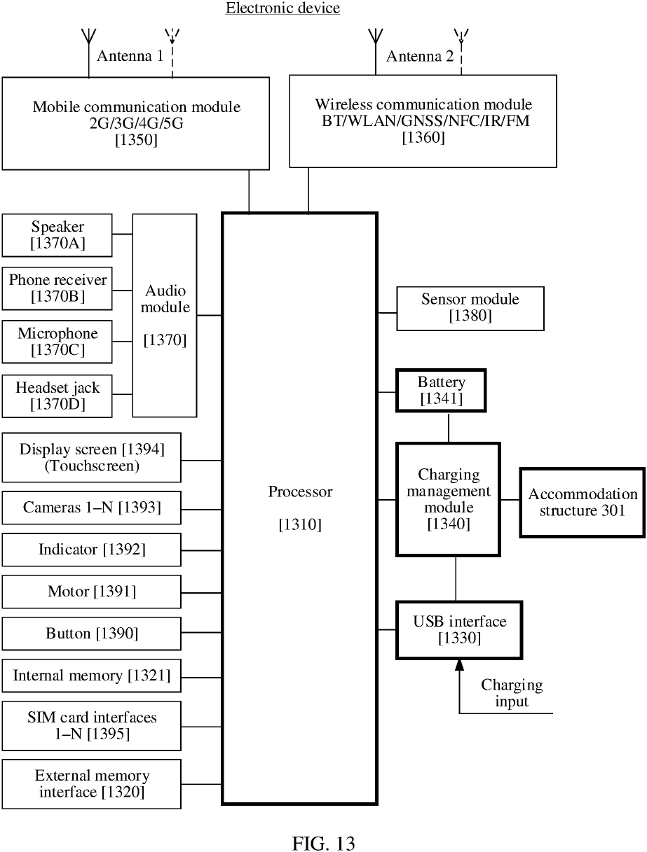

Exemplarily, FIG. 13 is a schematic structural diagram of an electronic device according to an embodiment of this application. The electronic device may include an accommodation structure 301 (in which a TX coil is arranged), a processor 1310, an external memory interface 1320, an internal memory 1321, a universal serial bus (universal serial bus, USB) interface 1330, a charging management module 1340, a battery 1341, an antenna 1, an antenna 2, a mobile communication module 1350, a wireless communication module 1360, an audio module 1370, a speaker 1370A, a phone receiver 1370B, a microphone 1370C, a headset jack 1370D, a sensor module 1380, a button 1390, a motor 1391, an indicator 1392, a camera 1393, a display screen 1394, a subscriber identity module (subscriber identification module, SIM) card interface 1395, and the like.

The sensor module 1380 may include a pressure sensor, a gyro sensor, a barometric pressure sensor, a magnetic sensor, an acceleration sensor, a distance sensor, an optical proximity sensor, a fingerprint sensor, a temperature sensor, and a touch sensor, an ambient light sensor, a bone conduction sensor, and the like.

It may be understood that an example structure in this embodiment of the present invention does not constitute a specific limitation on the electronic device. In some other embodiments of this application, the electronic device may include more or fewer components (for example, the electronic device may further include an RX coil) than those shown in the figure, or some components may be combined, or some components may be split, or components are arranged in different manners. The components shown in the figure may be implemented by hardware, software, or a combination of software and hardware.

The processor 1310 may include one or more processing units. For example, the processor 1310 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, and/or a neural-network processing unit (neural-network processing unit, NPU), and the like. Different processing units may be independent devices, or may be integrated into one or more processors.

A memory may be further arranged in the processor 1310, and is configured to store instructions and data. In some embodiments, the memory in the processor 1310 is a cache. The memory may store an instruction or data that has just been used or cyclically used by the processor 1310. If the processor 1310 needs to use the instruction or the data again, the processor may directly invoke the instruction or the data from the memory, to avoid repeated access and reduce a waiting time of the processor 1310, thereby improving system efficiency.

In some embodiments, the processor 1310 may include one or more interfaces. The interface may include an inter-integrated circuit (inter-integrated circuit, I₂C) interface, an inter-integrated circuit sound (inter-integrated circuit sound, I₂S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, and/or a USB interface.

The USB interface 1330 is an interface that conforms to a USB standard specification, and may be specifically a mini USB interface, a micro USB interface, a USB Type C interface, or the like. The USB interface 1330 may be configured to connect to the charger (such as a power adapter 1 or a power adapter 2 shown in FIG. 2) to charge the electronic device, or may be configured to transmit data between the electronic device and a peripheral device. The USB interface may also be connected to a headset to play audios through the headset. The interface may alternatively be configured to connect to another electronic device or mobile terminal such as an AR device.

It may be understood that an interface connection relationship between the modules illustrated in this embodiment of the present invention is merely an example for description, and does not constitute a limitation on a structure of the electronic device. In some other embodiments of this application, the electronic device may alternatively use an interface connection manner different from that in the foregoing embodiment, or use a combination of a plurality of interface connection manners.

The charging management module 1340 may be specifically the charging control circuit (such as the first charging control circuit 80₁ or the second charging control circuit 1002) described in the foregoing embodiments, and is configured to control a charging process of the electronic device.

In some embodiments, the electronic device may support wired charging. Specifically, the charging management module 1340 may receive a charging input from the wired charger through the USB interface 1330.

In other embodiments, the electronic device may support forward wireless charging, that is, the electronic device is an RX device. In this case, the charging management module 1340 may receive wireless charging input through an RX coil. The RX coil can transmit a generated alternating current signal to the charging management module 1340, so as to wirelessly charge the battery 1341.

In other embodiments, the electronic device may support reverse wireless charging, that is, the electronic device is a TX device. Specifically, the charging management module 1340 may alternatively receive input from the battery 1341, convert a direct current signal inputted from the battery 1341 into an alternating current signal, and then transmit the alternating current signal to the TX coil of the foregoing accommodation structure 301. The TX coil can generate an alternating current magnetic field when receiving the alternating current signal. After inducing the alternating current magnetic field, an RX coil of another mobile terminal (such as the foregoing stylus 320) can be wirelessly charged.

For detailed descriptions of wireless charging performed by the electronic device, reference may be made to introduction of the principle of wireless charging performed by the TX device in the foregoing example, and details are not described in this embodiment of this application.

A wireless communication function of the electronic device may be implemented by using the antenna 1, the antenna 2, the mobile communication module 1350, the wireless communication module 1360, the modem processor, the baseband processor, and the like.

The antenna 1 and the antenna 2 are configured to transmit or receive an electromagnetic wave signal. Each antenna in the electronic device may be configured to cover one or more communication frequency bands. Different antennas may also be multiplexed to improve utilization of the antennas. For example, the antenna 1 may be multiplexed as a diversity antenna of a wireless local area network. In some other embodiments, the antenna may be used in combination with a tuning switch.

The mobile communication module 1350 may provide a solution to wireless communication such as 2G/3G/4G/5G applied to the electronic device. The wireless communication module 1360 may provide a solution for wireless communication including a wireless local area network (wireless local area network, WLAN) (such as a wireless fidelity (wireless fidelity, Wi-Fi) network), Bluetooth (Bluetooth, BT), and a global navigation satellite system (global navigation satellite system, GNSS), frequency modulation (frequency modulation, FM), an NFC technology, an infrared (infrared, IR) technology, and the like to be applied to the electronic device. In some embodiments, in the electronic device, the antenna 1 is coupled to the mobile communication module 1350, and the antenna 2 is coupled to the wireless communication module 1360, so that the electronic device may communicate with a network and another device by using a wireless communication technology.

The electronic device implements a display function by using the GPU, the display screen 1394, the application processor, and the like. The GPU is a microprocessor for image processing, and is connected to the display screen 1394 and the application processor. The GPU is configured to perform mathematical and geometric calculation, and is configured to render graphics. The processor 1310 may include one or more GPUs, and execute program instructions to generate or change display information.

The display screen 1394 is configured to display an image, a video, and the like. The display screen 1394 includes a display panel. In some embodiments, the electronic device may include one or N display screens 1394, and N is a positive integer greater than 1.

The electronic device may implement a photographing function by using the ISP, the camera 1393, the video codec, the GPU, the display screen 1394, the AP, and the like. The ISP is configured to process data fed back by the camera 1393. In some embodiments, the ISP may be arranged in the camera 1393. The camera 1393 is configured to capture a static image or a video. In some embodiments, the electronic device may include one or N cameras 1393, and N is a positive integer greater than 1.

The external memory interface 1320 may be configured to connect to an external storage card, for example, a micro SD card, to expand a storage capability of the electronic device. The external storage card communicates with the processor 1310 by using the external memory interface 1320, to implement a data storage function, such as storing a file such as a music or a video in the external storage card.

The internal memory 1321 may be configured to store computer executable program code, and the executable program code includes instructions. The processor 1310 runs the instruction stored in the internal memory 1321, to perform various function applications and data processing of the electronic device. In addition, the internal memory 1321 may include a high-speed random access memory, or may include a non-volatile memory such as at least one magnetic disk memory, a flash memory, or a universal flash storage (universal flash storage, UFS).

The electronic device may implement an audio function such as music playback, recording, and the like by using the audio module 1370, the speaker 1370A, the phone receiver 1370B, the microphone 1370C, the headset jack 1370D, the application processor, and the like.

The audio module 1370 is configured to convert digital audio information into an analog audio signal output, and is further configured to convert an analog audio input into a digital audio signal. In some embodiments, the audio module 1370 may be arranged in the processor 1310, or some functional modules of the audio module 1370 are arranged in the processor 1310. The speaker 1370A, also referred to as a “horn”, is configured to convert an audio electrical signal into a sound signal. The phone receiver 1370B, also referred to as a “receiver”, is configured to convert an audio electrical signal into a sound signal. The microphone 1370C, also referred to as a “mouthpiece” or a “megaphone”, is configured to convert a sound signal into an electrical signal. At least one microphone 1370C may be arranged in the electronic device. The headset jack 1370D is configured to connect to a wired headset. The headset jack 1370D may be a USB interface 1330, or may be a 3.5 mm open electronic device platform (open mobile terminal platform, OMTP) standard interface, or a cellular telecommunications industry association of the USA (cellular telecommunications industry association of the USA, CTIA) standard interface.

The electronic device may further include components such as a key 1390, a motor 1391, an indicator 1392 (such as an indicator light), or a SIM card interface 1395. This is not limited in this embodiment of this application.

Through the descriptions of the foregoing implementations, a person skilled in the art may clearly understand that, for the purpose of convenient and brief description, only division of the foregoing functional modules is used as an example for description. In actual application, the foregoing functions may be allocated to and completed by different functional modules according to requirements. That is, an internal structure of an apparatus is divided into different functional modules to complete all or some of the functions described above. For specific work processes of the system, the apparatus and the unit described above, reference may be made to the corresponding processes in the foregoing method embodiments. Details are not described herein again.

In this embodiment of this application, functional units in the embodiments may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the embodiments of this application essentially, or the part contributing to the related art, or all or some of the technical solutions may be implemented in the form of a software product. The computer software product is stored in a storage medium and includes several instructions for instructing a computer device (which may be a personal computer, a server, a network device, or the like) or a processor to perform all or some of the steps of the methods described in the embodiments of this application. The foregoing storage medium includes: any medium that can store program code, such as a flash memory, a removable hard disk, a read-only memory, a random access memory, a magnetic disk, or an optical disc.

The foregoing descriptions are merely specific implementations of the embodiments of this application, but the protection scope of the embodiments of this application is not limited thereto. Any variation or replacement within the technical scope disclosed in the embodiments of this application shall fall within the protection scope of the embodiments of this application. Therefore, the protection scope of the embodiments of this application shall be subject to the protection scope of the claims.

1-9. (canceled)

10. A wireless charging apparatus, comprising:
an accommodation structure, comprising an accommodation cavity and a first wireless charging coil, and the first wireless charging coil is arranged around the accommodation cavity; and
a first charging control circuit connected to the first wireless charging coil, wherein the first charging control circuit is configured to output an alternating current signal to the first wireless charging coil, causing the first wireless charging coil to generate an alternating current magnetic field; and
wherein the accommodation cavity is configured to accommodate a stylus, and a second wireless charging coil is arranged in the stylus, and when the stylus is accommodated in the accommodation cavity, the second wireless charging coil is accommodated in the first wireless charging coil, to cause the second wireless charging coil to induce the alternating current magnetic field generated by the first wireless charging coil, to be coupled to the first wireless charging coil.

11. The apparatus according to claim 10, wherein a size of the accommodation cavity corresponds to a size of the stylus, and a shape of the accommodation cavity corresponds to a shape of the stylus.

12. The apparatus according to claim 10, wherein the apparatus further comprises a battery, wherein the battery is connected to the first charging control circuit; and
wherein the battery is configured to output a direct current signal to the first charging control circuit, and the first charging control circuit is configured to convert the direct current signal into an alternating current signal.

13. The apparatus according to claim 10, further comprising a charging interface, wherein the charging interface is connected to the first charging control circuit; and
wherein the charging interface is configured to obtain a direct current signal from a power adapter, a mobile power supply, or a first electronic device, and output the direct current signal to the first charging control circuit; and the first charging control circuit is configured to convert the direct current signal into an alternating current signal.

14. The apparatus according to claim 10, further comprising a third wireless charging coil, wherein the third wireless charging coil is connected to a second charging control circuit; and
wherein the third wireless charging coil is configured to receive an alternating current magnetic field generated by a second electronic device, to generate an alternating current signal, and output the generated alternating current signal to the second charging control circuit.

15. The apparatus according to claim 14, wherein the second charging control circuit is connected to a battery, wherein the second charging control circuit rectifies the received alternating current signal into a direct current signal, and outputs the direct current signal to the battery.

16. The apparatus according to claim 10, wherein the accommodation structure further comprises a casing, wherein the first wireless charging coil is arranged between the casing and the accommodation cavity.

17. The apparatus according to claim 10, wherein the apparatus is a Bluetooth keyboard, wherein the Bluetooth keyboard comprises a keyboard body and a cover plate, and the keyboard body and the cover plate are hingedly connected to each other by a rotary shaft, wherein a part or all of the rotary shaft is the accommodation structure.

18. The apparatus according to claim 10, wherein a magnetic core is arranged in a receiver coil of the stylus.

19. An electronic device, comprising:
one or more processors;
a memory; and
a wireless charging apparatus, comprising:
an accommodation structure, comprising an accommodation cavity and a first wireless charging coil, and the first wireless charging coil is arranged around the accommodation cavity; and
a first charging control circuit connected to the first wireless charging coil, wherein the first charging control circuit is configured to output an alternating current signal to the first wireless charging coil, causing the first wireless charging coil to generate an alternating current magnetic field; and
wherein the accommodation cavity is configured to accommodate a stylus, and a second wireless charging coil is arranged in the stylus, and when the stylus is accommodated in the accommodation cavity, the second wireless charging coil is accommodated in the first wireless charging coil, to cause the second wireless charging coil to induce the alternating current magnetic field generated by the first wireless charging coil, to be coupled to the first wireless charging coil.

20. The electronic device according to claim 19, wherein a size of the accommodation cavity corresponds to a size of the stylus, and a shape of the accommodation cavity corresponds to a shape of the stylus.

21. The electronic device according to claim 19, wherein the wireless charging apparatus further comprises a battery, wherein the battery is connected to the first charging control circuit; and
wherein the battery is configured to output a direct current signal to the first charging control circuit, and the first charging control circuit is configured to convert the direct current signal into an alternating current signal.

22. The electronic device according to claim 19, wherein the wireless charging apparatus further comprises a charging interface, wherein the charging interface is connected to the first charging control circuit; and
wherein the charging interface is configured to obtain a direct current signal from a power adapter, a mobile power supply, or a first electronic device, and output the direct current signal to the first charging control circuit; and the first charging control circuit is configured to convert the direct current signal into an alternating current signal.

23. The electronic device according to claim 19, wherein the wireless charging apparatus further comprises a third wireless charging coil, wherein the third wireless charging coil is connected to a second charging control circuit; and
wherein the third wireless charging coil is configured to receive an alternating current magnetic field generated by a second electronic device, to generate an alternating current signal, and output the generated alternating current signal to the second charging control circuit.

24. The electronic device according to claim 23, wherein the second charging control circuit is connected to a battery, wherein the second charging control circuit rectifies the received alternating current signal into a direct current signal, and outputs the direct current signal to the battery.

25. The electronic device according to claim 19, wherein the accommodation structure further comprises a casing, wherein the first wireless charging coil is arranged between the casing and the accommodation cavity.

26. The electronic device according to claim 19, wherein the wireless charging apparatus is a Bluetooth keyboard, wherein the Bluetooth keyboard comprises a keyboard body and a cover plate, and the keyboard body and the cover plate are hingedly connected to each other by a rotary shaft, wherein a part or all of the rotary shaft is the accommodation structure.

27. The electronic device according to claim 19, wherein a magnetic core is arranged in a receiver coil of the stylus.
